(19) United States
(12) Patent Application Publication
(10) Pub. No.: US 2011/0310854 A1
(43) Pub. Date: Dec. 22, 2011

(54) METHOD OF DETERMINING ACCESS TIMES FOR WIRELESS COMMUNICATION DEVICES

(76) Inventors: JIALIN ZOU, Randolph, NJ (US); SUDEEP PALAT, Swindon (GB)

(21) Appl. No.: 12/817,501

(22) Filed: Jun. 17, 2010

(51) Int. Cl. H04W 72/12

(52) U.S. Cl. 370/336; 370/345; 370/350

(57) ABSTRACT

The present invention provides a method of determining access times for a wireless committee case in device. One embodiment of the method includes selecting one of a plurality of time intervals in a periodically repeating access cycle for transmission of an access request. The selection is performed based on information identifying the wireless communication device. This embodiment of the method also includes transmitting the access request over a random access channel in the selected one of the plurality of time intervals.

### BACKGROUND OF THE INVENTION

1. Field of the Invention

This invention relates generally to communication systems, and, more particularly, to wireless communication systems.

2. Description of the Related Art

Service providers are beginning to develop, offer, and deploy a new type of wireless communication device that is referred to as a machine-type communication device. A machine type device differs from traditional human-to-human (H2H) communication devices because they typically involve communication between entities that do not necessarily need human interaction. For example, machine type devices can be wireless user equipment configured to gather measurement information and report this information to a central server at a particular time interval. Machine type devices can be used in a wide variety of contexts such as remote meter reading for water and power companies, wireless burglar and/or fire alarm monitoring, weather monitoring, vehicle tracking, medical monitoring, and the like.

Machine type devices have operational characteristics that differ markedly from the operational characteristics of conventional human-to-human (H2H) wireless communication devices. Conventional H2H communication usually requires allocating resources for substantially continuous duplex communication between users for intervals as long as several minutes or even hours. In contrast, machine type devices typically transmit relatively small amounts of information in bursts that are separated by relatively long and sometimes irregular intervals. For example, a device that is used to remotely read a water meter may only transmit a burst of information indicating water usage for a household once a month. For another example, a burglar alarm monitor may only transmit bursts of information when the alarm is triggered. Consequently, machine type devices are also typically significantly more delay tolerant than conventional H2H devices since voice communication requires delays of less than 100 ms or better. A device that reads and reports water usage may be able to tolerate transmission delays of days or even weeks. Moreover, machine type devices are often fixed to particular locations and so the mobility of these devices may be significantly lower than the expected mobility of a H2H device.

The distribution of machine type devices is expected to be significantly different than the distribution of handheld wireless communication devices. Current generations (2G/3G) of wireless communication systems have been designed to accommodate capacities on the order of 100 users per cell based on expected densities of H2H devices. However, the number of machine type devices in each cell is expected to be at least an order of magnitude higher and each cell may have to support thousands of machine type devices. Randomly transmitted access signals from such a large number of machine type devices, such as access requests transmitted over a random access channel, will almost certainly lead to a very large number of collisions. Furthermore, transmissions from some kinds of machine type devices tend to be strongly correlated in time. For example, an office building may have a very large number of remotely-monitored fire alarms. Under normal conditions the fire alarms generate virtually no traffic except perhaps a periodic “I'm alive” pulse to verify they are operating. However, if a fire breaks out all of the alarms may begin to concurrently transmit large bursts of information. Correlated bursts of information from large numbers of machine type devices in a cell can generate overload conditions, congestion, and collisions between access signals.

One proposal for flattening the time distribution of access signals from machine type devices is to allow a central entity to schedule the access signals using a polling scheme. The polling based scheme requires a central entity in the network (such as the E-UTRAN) to page each device at a predetermined reporting time to determine whether the device has information to transmit. Although one-by-one paging of the devices by the E-UTRAN scheduler could avoid collisions, this approach introduces a lot of signaling overhead particularly over the forward link. The efficiency gains from flattening the access transmission distribution are not thought to justify the high cost in overhead and complexity introduced by this method.

An alternative proposal is to apply the conventional random access method with access barring mechanisms such as using random back-offs to resolve collisions between the random access signals (access probes). Although this approach can flatten the time distribution of the access signals, the overhead costs would be considerable. For example, a large number of access collisions may be generated if a large number of machine type devices send random access request signals at the same time. Backing off some of the request signals would flatten the distribution but may still lead to additional collisions between retransmissions when the number of requesting devices is large. The efficiency of the system is therefore reduced (and the reverse link signaling overhead increased) by using back-offs and retransmissions to resolve the collisions. The retransmissions may also introduce more delay of reports from the devices and create more uncertainty on the actual reporting time.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for determining access times for a wireless committee case in device. One embodiment of the method includes selecting one of a plurality of time intervals in a periodically repeating access cycle for transmission of an access request. The selection is performed based on information identifying the wireless communication device. This embodiment of the method also includes transmitting the access request signal over a random access channel in the selected one of the plurality of time intervals.

In another embodiment, a method is provided for determining access times for a wireless communication device. One embodiment of the method includes constraining a wireless communication device to transmit access signals over a random access channel during one of a plurality of time intervals that make up a periodically repeating access cycle.

In yet another embodiment, a method is provided for determining access times for a wireless communication device. One embodiment of the method includes broadcasting, from a base station, information defining a plurality of time slots that make up a periodically repeating access cycle for a random access channel. Each wireless communication device served by the base station is constrained to transmit access request signals over the random access channel during a selected one of a plurality of time slots.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one exemplary embodiment of a wireless communication system;

FIG. 2 conceptually illustrates one exemplary embodiment of a timing diagram for a random access channel;

FIG. 3 conceptually illustrates one exemplary embodiment of a method of transmitting access requests; and

FIG. 4 conceptually illustrates one exemplary embodiment of a method of monitoring access requests.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

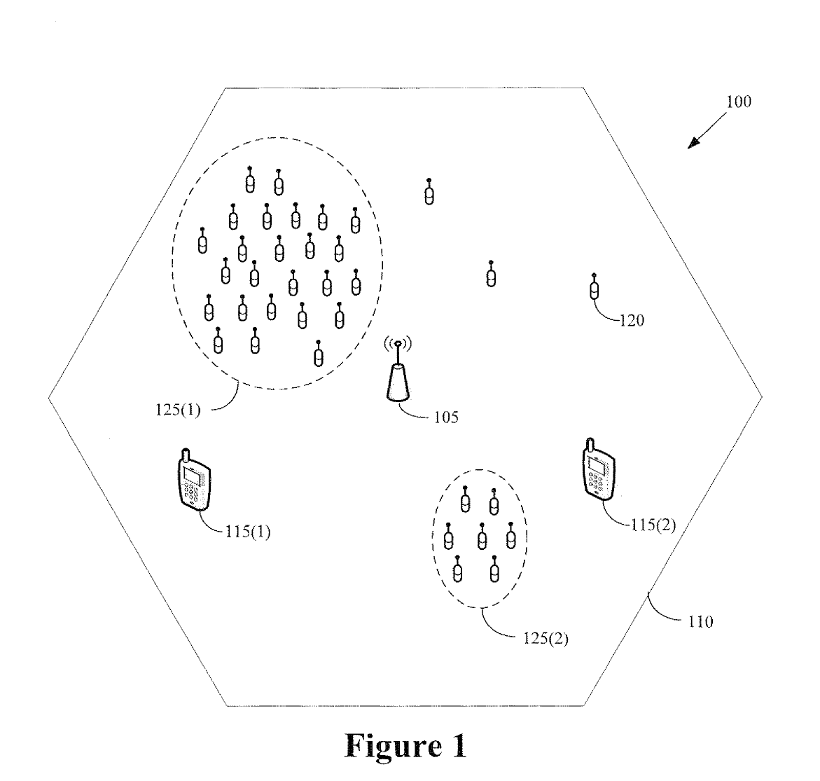

FIG. 1 conceptually illustrates one exemplary embodiment of a wireless communication system 100. In the illustrated embodiment, the wireless communication system 100 includes a base station 105 that provides wireless connectivity within a geographic region or cell 110. The cell 110 is depicted as a perfect hexagon in FIG. 1. However, persons of ordinary skill in the art having benefit of the present disclosure should appreciate that this is an idealization and actual cells may have irregular and/or time varying boundaries. Furthermore, in alternative embodiments, the base station 105 may be configured to provide wireless connectivity within portions or sectors of the cell 110, e.g., using multiple antennas or arrays of antennas. Wireless connectivity can be provided using well known standards and/or protocols and in the interest of clarity only those aspects of the standards and/or protocols that are relevant to the claimed subject matter are discussed herein. For example, wireless connectivity in the system 100 may be provided according to wireless standards and/or protocols including TDMA, FDMA, CDMA, UMTS, LTE, WiMAX and the like.

One or more human-to-human (H2H) wireless communication devices 115(1-2) may be located within the cell 110. The H2H devices 115 may use a wireless connection to the base station 105 to communicate with each other or other devices. Exemplary H2H devices 115 may include cellular phones, smart phones, notebook computers, laptop computers, and the like. Machine type wireless communication (MTC) devices 120 may also be distributed throughout the cell 110. In the interest of clarity, only one of the MTC devices is specifically indicated with the numeral “120.” The number of MTC devices 120 shown in FIG. 1 is intended to be illustrative. Persons of ordinary skill in the art having benefit of the present disclosure should appreciate that an actual deployment of MTC devices 120 may include hundreds or thousands of MTC devices 120 within the cell 110.

In some embodiments, some of the MTC devices 120 are parts of groups 125(1-2). For example, the MTC devices 120 in the group 125(1) may be fire alarms or smoke detectors within a particular building. For another example, the MTC devices 120 in the group 125(2) may be wireless detectors that form part of a security system for a building such as open-door detectors, glass break detectors, motion sensors, and the like. The MTC devices 120 in a group 125 do not necessarily need to be physically proximate to each other. For example, a group 125 of MTC devices 120 may be deployed in taxicabs and used to provide periodic location reports to a dispatcher.

The MTC devices 120 implement one or more MTC applications that provide reports over the air interface to the base station 105 at particular intervals. In one embodiment, an application operating on the MTC devices 120 may support periodic short data reporting. Alternatively, the application may provide data in response to a request from received from the base station 105 or in response to the occurrence of some condition or criteria. The reporting interval can vary significantly depending on the type of application and may range from less than one minute to more than one month. In some embodiments that allow the MTC device 120 to report very frequently, e.g. at intervals much shorter than a minute, the MTC device 120 may remain in the active mode and skip the access process, thereby reducing or avoiding the access collision issue in these circumstances. Moreover, the precise transmission time can vary within a tolerance that can be a fairly large percentage of the overall reporting interval, e.g., around 1-10% of the interval, although the exact tolerance may be different for different applications. The reported data may include values of measurements such as time-of-day, temperatures, locations, test conditions/results, environmental conditions, and the like. The measurements may be performed using sensors incorporated within the MTC devices 120 or may be provided to the MTC devices 120 via external devices for transmission over the air interface.

The large number of MTC devices 120 within the cell 110 may lead to collisions between reverse link access transmissions from the MTC devices 120. For example, large numbers of access request signals over random access channels may lead to a relatively large number of collisions. In one embodiment, the MTC devices 120 may share the same random access channels as the H2H devices 115 in which case the access requests from the MTC devices 120 may also collide with access requests from the H2H devices 115. Alternatively, the MTC devices 120 and the H2H devices 115 may utilize different channels to prevent collisions between transmissions by the two types of devices. Moreover, access request by MTC devices 120 within the groups 125 can be strongly correlated in time and space. For example, if a fire breaks out in the building that contains the MTC devices 125(1), it is likely that many if not all of these devices 125(1) may transmit access requests concurrently or even simultaneously. Such a large number of concurrent access requests can lead to a correspondingly large number of collisions between these access requests.

Access requests by the different MTC devices 120 can be coordinated to attempt to reduce collisions between reverse link traffic. In one embodiment, the temporal structure of the reverse link can be divided into a series of periodically repeating access cycles that are subdivided into time intervals such as time slots of the reverse link channel. The MTC devices 120 may attempt to reduce the incidence of access request collisions by selecting one of the time intervals in each access cycle for transmission of access requests. For example in a LTE system, each MTC device 120 may select a time slot in the access cycle by comparing system frame numbers (SFNs) of the slots to their internal identifiers, as discussed herein. Access requests can then be transmitted over the random access channel in the selected time intervals. In other embodiments, the MTC devices 120 can be constrained in other ways to transmit access signals over a random access channel during one of the time intervals that make up a periodically repeating access cycle. For example, the MTC device 120 may be constrained to transmit access requests in the slot immediately following a paging slot assigned to the MTC device 120.

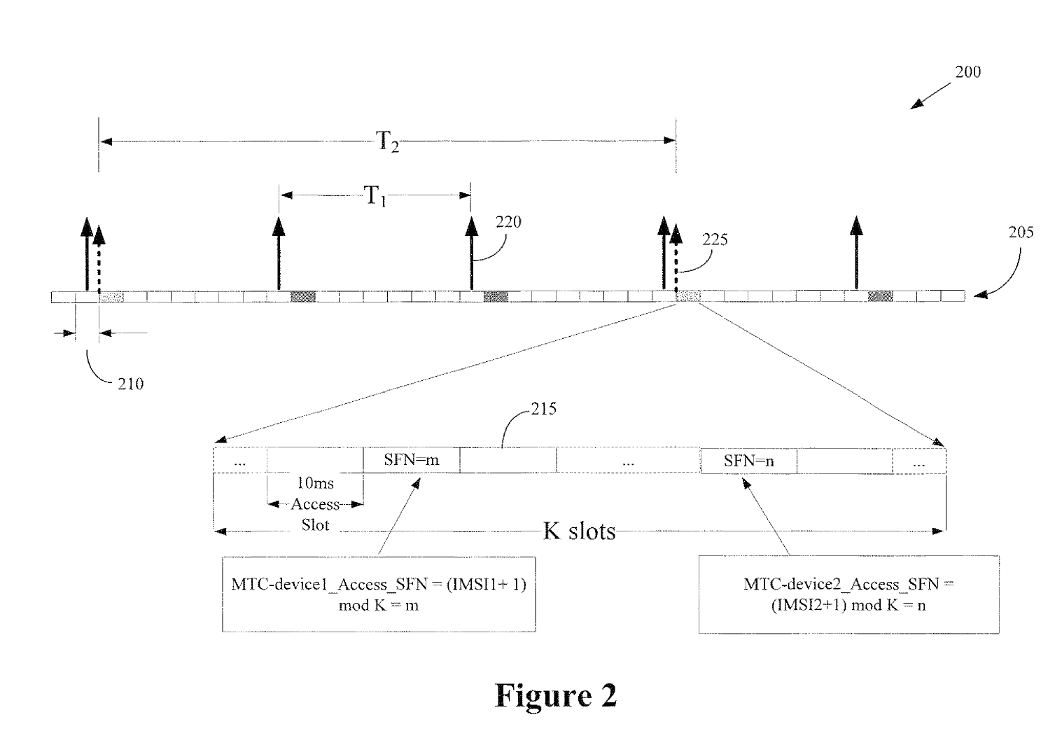

FIG. 2 conceptually illustrates one exemplary embodiment of a timing diagram 200 for a random access channel 205. The timing diagram 200 depicts events that may occur in one embodiment of a slotted access method used by MTC devices such as the MTC devices 120 depicted in FIG. 1. In the illustrated embodiment, two MTC devices transmit access request signals in accordance with their reporting cycles. Each MTC device is constrained so that it is only allowed to transmit the access request in its own access slot within an access cycle. Constraining access request transmission in this way can reduce or minimize the chance of access collision by making the MTC devices transmit access requests in a pre-scheduled fashion. The access slots are selected by and/or for each MTC device using identifying information that is available to both the MTC device and the network. The access timing may therefore be predictable at both the network and the MTC device without signaling.

The random access channel 205 is temporally divided into periodically repeating access cycles 210. Each access cycle has a length of K time intervals. In one embodiment, the unit of the access cycle 210 is the system frame and the boundaries of the access cycle 210 are aligned with the system frames. For example if K=4096, then each access cycle 210 has 4096 access slots 215 with a slot duration that is equal to one system frame duration (e.g., 10 ms). The period of the access cycle 210 is about 41 s. However, persons of ordinary skill in the art having benefit of the present disclosure should appreciate that the value of K can be different for different cells and different deployment configurations. In one embodiment, the network could determine the value of K for a cell based on an estimate or an expectation of the total number of MTC devices that may be deployed in the cell. Cells that handle smaller numbers of MTC devices could set K to a lower value, e.g. 1024, and cells that handle even larger numbers of MTC devices could have larger values of K.

The two MTC devices implement applications that have reporting intervals of T₁ and T₂, respectively. The application in the first MTC device initiates transmission of an access request at the times indicated by the solid arrows 220 and the application of the second MTC device initiates transmission of access requests that the times indicated by the dashed arrows 225. In response to initiation of the access request by the application, the MTC device selects an access slot in the next access cycle to use to transmit the access request and in some cases the two MTC devices may initiate transmission of access requests during the same access cycle. Access requests transmitted by either of the MTC devices may also potentially collide with transmissions by other devices during the same access cycle.

Collisions can be avoided by selecting an access slot 215 in the access cycle 210 based upon information associated with and/or identifying the different MTC devices. In the illustrated embodiment taking LTE as an example, access slots 215 can be identified using the value of the system frame number modulo the number of slots in the access cycle (SFN mod K). The SFN can be broadcast from cell or base stations in a master information block (MIB) that may also include information indicating the LTE downlink bandwidth (DL BW), number of transmit antennas, PHICH duration, its gap, and possibly other information. By tracking the broadcast SFN information, the MTC devices may be synchronized with the same access cycle and the access slots. Each MTC device is allowed to access slots that are selected based on a comparison of the SFN and information identifying the MTC device. For example, each MTC device can use its international mobile subscriber identity (IMSI) to select the slot whose SFN mod K=(IMSI+1)mod K. However, persons of ordinary skill in the art having benefit of the present disclosure should appreciate that other techniques can be used to choose slots. For example, the slots could be chosen based upon the most significant bits of the IMSI, the least significant bits of the IMSI, a pseudorandom number generated by hashing the IMSI, and the like. In order to minimize the chance of collision between MTC device access and paging, the SFN cycle broadcast by the system should be selected to be long enough to support the synchronization of a long enough access cycle. For example in current LTE standard, 4 MSBs of SFN could be added to the MIB to ensure that the MTC access cycle and paging cycle are long enough. For example, if K=4096, there will be 4096 unique m-device IDs could be supported in a cell. Thousands of MTC devices could therefore be accommodated in an access cycle without collision.

In one embodiment, power can be saved by the MTC devices by aligning the MTC access cycle with the paging cycle. The MTC device wakes up at its paging slot to see if any pages are being sent by the network. Selecting the access slot of the MTC device to be the slot after the paging slot allows the MTC device to remain in the active state for an additional slot as opposed to having to cycle through the sleeping and waking-up processes between paging slots and access slots. A longer DRX/paging cycle may be defined for MTC devices in some embodiments to accommodate the large number of MTC devices when paging is supported for MTC devices. For example, the paging cycle and access cycle could be configured so that the paging cycle=access cycle>=DRX cycle. Setting the paging cycle to be smaller than the DRX cycle would therefore not be allowed for MTC devices in this embodiment. Considering certain low cost MTC devices may not support paging and/or data polling, when data reporting is triggered by application, these devices may be able to acquire synchronization for access in the next access slot when they wake up at their paging slot. In one embodiment, the access slot may be selected to be the same slot as the paging slot of a MTC device as long as the system implements a mechanism to prevent conflicts or duplication between the paging driven access and automated access.

Collisions or other access failures may still occur even when the slot selection technique described herein is employed especially in embodiments in which MTC devices share the same access channel with the H2H user equipment. In cases where the initial access attempt fails, the MTC device may proceed according to a number of alternative embodiments. In the first embodiment, the MTC device follows existing retry procedures (e.g. a random back-off) and then attempts to perform the access again. The merit of this approach is no further standards changes are required. However there may be an increased chance of access collision because the retry attempt is a random access. In the second embodiment, the MTC device backs off to the next access cycle and then the retries at its selected access slot in the next access cycle. This approach has very low chance of collision and the procedures are easier to implement than conventional random access procedures with access barring. The drawback of this option may be the back-off delay that results from the MTC device having to wait till next access cycle to perform access. However, for MTC devices the access cycle delay is typically tolerable. For example, a delay that is approximately as long as the access cycle of 4096 frames would be approximately 41 s, which is not significant when compared to a much longer data reporting cycle e.g. 30 min. In a third embodiment, the network schedules the retry attempt. For example, the network can determine which access slot a MTC device can use to transmit an access request signal. If the access request is not received, the network may poll that MTC device. The merit of this approach is that the retry delay and retry collision may be reduced. However the complexity of the network functionality used to support MTC devices may be increased significantly.

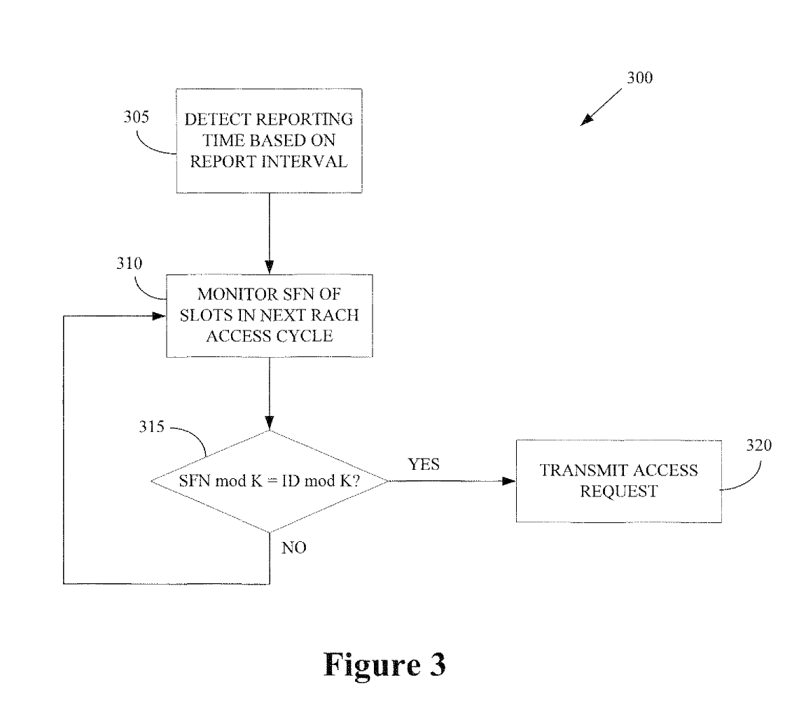

FIG. 3 conceptually illustrates one exemplary embodiment of a method 300 of transmitting access requests. In the illustrated embodiment, an MTC device detects (at 305) a reporting time based on a reporting time interval. For example, an application running on the MTC device may determine that the reporting time interval has elapsed since the last report and so may signal the MTC device to access the network to provide the report. The MTC device may identify its next available access slot for access. If its access slot has already passed in this access cycle, the MTC device may monitor (at 310) system frame numbers of the slots of the next available access cycle to determine SFNs of the slots and select or identify its time slot by comparing the SFNs to an identifying number such as the MTC device's IMSI. In the illustrated embodiment, the access cycle includes K slots and the MTC device selects the slot that has a SFN that satisfies the condition (at 315) that SFN mod K=ID mod K. However, as discussed herein, the MTC device can use other criteria for selecting (at 315) a slot to transmit an access request. The MTC device transmits (at 320) the access request in the pre-selected slot of the random access channel.

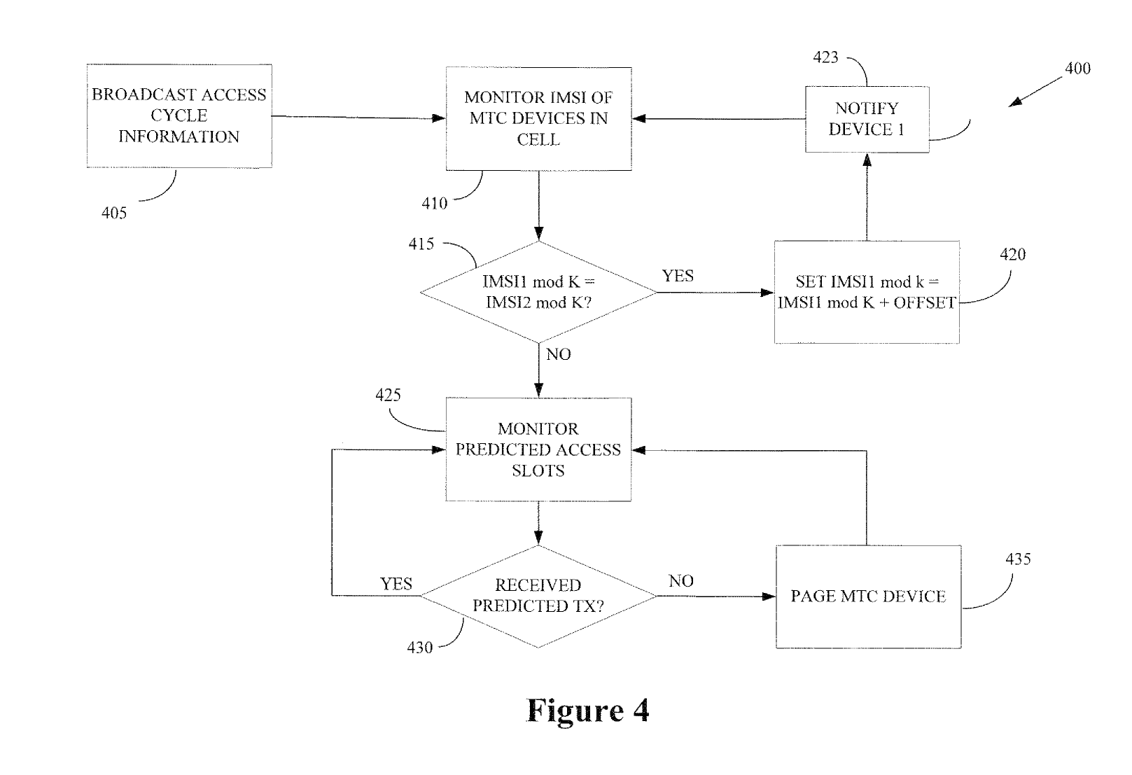

FIG. 4 conceptually illustrates one exemplary embodiment of a method 400 of monitoring access requests. In the illustrated embodiment, the method 400 may be implemented in a base station, a base station router, access point, or any other device or devices that are used to provide wireless connectivity to MTC devices and/or H2H user equipment. An access cycle is determined for the MTC devices and then broadcast (at 405) over the air interface into the cell and/or a sector associated with the base station. As discussed herein, the access cycle defines the temporal structure of the reverse link by dividing transmission intervals into a series of periodically repeating access cycles that are subdivided into time intervals such as time slots of the reverse link channel. The period of the access cycle (K) can be determined by the base station or may be provided to the base station by some other entity. The MTC devices monitor and track the broadcast access slot numbers (SFN) and the access cycle. They may therefore be synchronized with the same access slot number and cycle.

The base station determines or monitors (at 410) the information identifying the MTC devices (or other user equipment) located within the cell. In the illustrated embodiment, each MTC device and other mobile unit is assigned an international mobile subscriber identifier (IMSI) that can be communicated to the base station. The base station can determine (at 415) whether the information used by different MTC devices to access slots is the same. For example, the base station can determine (at 415) whether IMSI1 mod K=IMSI2 mod K for devices having IMSI values of IMSI1 and IMSI2. If these values are the same, the chance of a collision between these two devices on the random access channel may be increased. The base station can therefore apply (at 420) an offset value to at least one of the values so that the two devices will select different slots in the access cycle. The base station can page one of the MTC devices and notify (at 423) the MTC device of the slot offset. Then the MTC device can perform access at the slot with the slot number equal to the number based on IMSI plus the offset. In this way the MTC device can be guided to an access slot not occupied in this cell. This process may be repeated until all of the MTC devices and/or user equipment within the cell have unique values of the information used to select slots in the access cycle. However, in some embodiments, overlap between the identifying information may be tolerable, e.g., if devices sharing the same information are not expected to collide frequently.

In another embodiment, instead of a MTC device determine its access slot by itself based on the device ID, the base station of the cell could assign a dedicated access slot number to the MTC device through signaling. For example, the base station could transmit a dedicated access slot number to the MTC device when the MTC device is first deployed in the cell or sector served by the base station. The dedicated access slot numbers to be drawn from a pool of available access slot numbers to avoid collisions with MTC devices that were previously assigned other dedicated access slot numbers from the pool. This embodiment can reduce or eliminate collisions between MTC devices within a particular cell at the cost of more signaling overhead and complexity when the MTC devices are first deployed. However, many MTC devices are fixed or have very limited mobility and so they are not expected to leave their initial cell frequently. Some MTC devices are expected to remain in their initial cell for their entire operational lifetime. The additional cost of allowing the base station to select the dedicated access slot numbers and transmit them to the MTC devices may therefore be relatively small when averaged over the life of the MTC device.

The base station can use the identifying information to predict and monitor (at 425) the access slots used by the MTC devices and/or other user equipment. When the base station receives (at 430) information from the MTC devices and/or user equipment in the predicted slots, then it can continue to monitor the access slots. However, an error may have occurred if no information is successfully received from the MTC devices and/or other user equipment in the predicted slots. For example, the wireless communication device may fail to transmit the access request in the selected access slot. For another example, the wireless communication device may transmit the access request but the base station may fail to properly decode the received transmission. The base station may therefore page (at 435) the MTC device and/or other user equipment that was expected to transmit in the monitored access slot. The page can be used to determine whether the MTC device (or other user equipment) is operating correctly within the cell.

Embodiments of the techniques described herein have a number of advantages over conventional approaches. For example, constraining each MTC device to transmit access requests a particular slot of an access cycle can reduce or minimize the chance of access collisions with other MTC devices and/or other H2H devices. Reducing collisions allows the radio resources to be used more efficiently, e.g., by reducing the signaling overhead required to schedule access requests and by reducing the number of retransmissions that results from collisions and subsequent back-off transmissions. For another example, the reporting time of a MTC device is more predictable (relative to random access) at the network because the network already knows the information that is used to select the access slot, e.g., the SFN and the IMSI of the MTC device. Forward link overhead and/or congestion in the access slot selection approach is smaller than in the polling approach for the same level of collision performance. Moreover, the impact to the existing mechanism is small. For example, embodiments of the techniques described herein approach could be applied on top of the conventional MTC device random access and/or random access with separate RACH resource allocations.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
selecting, at a wireless communication device, one of a plurality of time intervals in a periodically repeating access cycle for transmission of an access request, the selection being performed based on an identification number identifying the wireless communication device; and
transmitting the access request over a random access channel in the selected one of the plurality of time intervals.

2. The method of claim 1, comprising defining the plurality of time intervals in the access cycle based on synchronization information broadcast over an air interface to the wireless communication device so that the wireless communication device is synchronized with other wireless communication devices on the same access cycle with the same numbering of the access intervals.

3. The method of claim 2, wherein the plurality of time intervals are a plurality of time slots in the periodically repeating access cycle, and wherein selecting one of the plurality of time intervals comprises selecting one of the plurality of time slots based on a slot numbering comprising system frame number associated with the selected one of the slots and broadcast over the air interface.

4. The method of claim 3, wherein selecting one of the plurality of time slots comprises selecting a time slot associated with a system frame number when the system frame number modulo a period of the access cycle is equal to the identification number modulo the period.

5. The method of claim 3, wherein selecting one of the plurality of time slots comprises selecting a time slot associated with a system frame number when the system frame number is equal to a selected portion or permutation of the identification number.

6. The method of claim 3, wherein selecting one of the plurality of time slots comprises selecting a time slot associated with a system frame number when the system frame number is equal to a hash of the identification number.

7. The method of claim 3, wherein selecting one of the plurality of time slots comprises selecting a time slot associated with a system frame number assigned by a base station as the identification number of the access slot of the device.

8. The method of claim 1, wherein a period of the access cycle is equal to a period of a paging cycle for the wireless communication device, and wherein selecting said one of the plurality of time intervals for the access request comprises selecting a time interval immediately following a time interval assigned for paging the wireless communication device.

9. The method of claim 1, wherein selecting said one of the plurality of time intervals comprises selecting one of the plurality of time intervals in an access cycle determined by a reporting interval for the wireless communication device.

10. The method of claim 9, comprising receiving a paging message in response to at least one of the wireless communication device not transmitting an access request or a base station failing to decode the access request during the access cycle determined by the reporting interval for the wireless communication device.

11. The method of claim 1, comprising retransmitting the access request in said selected one of the plurality of time intervals in a subsequent access cycle when the transmission of the access request fails.

12. A method, comprising:
constraining a wireless communication device to transmit access signals over a random access channel during one of a plurality of time slots that make up a periodically repeating access cycle.

13. The method of claim 12, wherein constraining the wireless communication device to transmit in said one of the plurality of time slots comprises constraining the wireless communication device to transmit in one of the plurality of time slots associated with a system frame number when the system frame number modulo a period of the access cycle is equal to the identification number modulo the period.

14. The method of claim 12, wherein constraining the wireless communication device to transmit in said one of the plurality of time slots comprises constraining the wireless communication device to transmit in a time slot associated with a system frame number when the system frame number is equal to a selected portion of the identification number, when the system frame number is equal to a hash of the identification number, or when the system frame number is pre-assigned by the base station.

15. The method of claim 12, wherein a period of the access cycle is equal to a period of a paging cycle for the wireless communication device, and wherein constraining the wireless communication device to transmit in said one of the plurality of time intervals comprises constraining the wireless communication device to transmit in a time interval immediately following or at a time interval assigned for paging the wireless communication device.

16. The method of claim 12, comprising transmitting the access request from the wireless communication device in said one of the plurality of time intervals during an access cycle determined by a reporting interval for the wireless communication device.

17. The method of claim 16, comprising receiving, at the wireless communication device, a paging message in response to at least one of the wireless communication device not transmitting an access request or the base station failing to decode the access request during the access cycle determined by the reporting interval for the wireless communication device.

18. The method of claim 16, comprising retransmitting the access request in said one of the plurality of time intervals in a subsequent access cycle when the transmission of the access request fails.

19. A method, comprising:
broadcasting, from a base station, information defining a plurality of time slots that make up a periodically repeating access cycle for a random access channel, wherein each wireless communication device served by the base station is constrained to transmit access request signals over the random access channel during a selected one of a plurality of time slots.

20. The method of claim 19, comprising predicting the selected one of the plurality of time slots used by each wireless communication device to transmit an access request signal over the random access channel and paging at least one wireless communication device when the base station does not successfully decode an access request signal during the predicted time slot.

21. The method of claim 19, comprising determining information used by each wireless communication device to select said one of the plurality of time slots and applying an offset to said information when said information for more than one wireless communication device is the same.
